(19) United States
(12) Patent Application Publication
(10) Pub. No.: US 2012/0213977 A1
(43) Pub. Date: Aug. 23, 2012

(54) PROCESS FOR PARTIAL SHRINKAGE COMPENSATION IN PLASTICS MOULDINGS

(75) Inventors: Roland Künzel, Leverkusen (DE); Armin Berger, Langenfeld (DE); Rainer Protte, Dormagen (DE); Thomas Klimmasch, Leverkusen (DE)

(73) Assignee: Bayer MaterialScience AG, Leverkusen (DE)

(21) Appl. No.: 13/367,502

(22) Filed: Feb. 7, 2012

(30) Foreign Application Priority Data
Feb. 17, 2011 (EP) 11154822.8

(51) Int. Cl. B32B 3/00; B29C 45/72; B29C 45/00

(52) U.S. Cl. 428/195.1; 264/328.8

(57) ABSTRACT

The present invention relates to a process for the production of a plastics moulding, comprising (A) back-injecting a plastic film on a first side with at least one thermoplastic plastic, wherein one or more partial areas of the plastics film are not back-injected, (B) cooling the plastics moulding obtained in step A), and (C) subsequently heating at least those regions of the plastics moulding obtained in step B) that have not been back-injected again.

### CROSS REFERENCE TO RELATED APPLICATIONS

Priority is claimed to European Patent Application No. 11154822.8, filed Feb. 17, 2011, which is incorporated herein by reference in its entirety for all useful purposes.

### BACKGROUND

The present invention relates to a process for the production of plastics mouldings, in which partial shrinkage compensation has been carried out, and to plastics mouldings produced by this process.

In the production of components in which partial transparency is desirable in the finished component—such as, for example, operating consoles in the automotive sector, the operating buttons of which are to be made visible to the user in the dark by means of partial backlighting—it is state of the art that optionally printed plastics films are back-injected with a thermoplastic plastic by means of the window technique. The process of back-injecting plastics films with thermoplastic plastics by means of the injection-moulding process is referred to as film insert moulding (FIM). The so-called window technique offers the possibility of covering the areas that are later to be back-lit with dies or sliders, thus keeping them free of thermoplastic plastics material.

However, this process has the problem that, in the processing of thermoplastic plastics by the injection-moulding process, the component shrinks on cooling but the film does not at the same time shrink in the regions that have not been back-injected. As a result, bulges or dents occur in those regions, which lead to noticeable unevenness of the surface of the component.

Hitherto, this problem has been lessened either by filling the thermoplastic plastics for back-injection with glass fibres, because shrinkage of the plastics material can thereby be reduced, or by using very thick films in order to prevent the formation of bulges or dents. However, it has not hitherto been possible to eliminate the problem completely by either of the two possibilities without further problems arising at the same time in terms of the end use. The use of glass fibres as an additional filler not only involves additional material costs and an additional outlay in terms of apparatus but also leads to increased tool wear during the processing of the filled plastics composition. In addition, the formation of bulges or dents could in many cases be reduced but not avoided completely by this measure. As well as involving additional material costs for the greater foil thickness, the use of thicker plastics films reduces the light transmission thereof—in particular when the film has additionally also been printed—and requires stronger light sources for adequate back-lighting. In addition, the component is under stress in the regions that have not been back-injected, which involves the risk of cracking or fracture in those regions.

Consequently, there was a need to provide a process for the production of components in which partial transparency is desired in the finished component, which does not exhibit the disadvantages mentioned above.

The object underlying the present invention was, therefore, to find such a process for the production of components in which partial transparency is desired in the finished component. In particular, the formation of bulges or dents in the finished component is to be avoided without having to accept additional material costs. In addition, the light transmission of the component in the areas to be back-lit is to be as high as possible so that back-lighting is possible even with weak, energy-saving light sources.

Surprisingly, this object has been achieved by a process for the production of a plastics moulding in which an optionally printed plastics film is back-injected with thermoplastic plastic over part of its surface and, after cooling, is subjected to after-shrinkage by at least partial heating.

### BRIEF DESCRIPTION OF PREFERRED EMBODIMENTS

An embodiment of the present invention provides a process for the production of a plastics moulding, comprising:
A) back-injecting a plastic film on a first side with at least one thermoplastic plastic, wherein one or more partial areas of the plastics film are not back-injected,
B) cooling the plastics moulding obtained in step A), and
C) subsequently heating at least those regions of the plastics moulding obtained in step B) that have not been back-injected again.

Another embodiment of the invention provides the above process, wherein the plastic film used in step A) is formed.

Another embodiment of the invention provides the above process, wherein the plastic film used in step A) is printed on one side.

Another embodiment of the invention provides the above process, wherein in step C) at least those regions of the plastics moulding obtained in step B) that have not been back-injected are heated to at least a temperature in the region above the temperature of 70° C. below the glass transition temperature T_{g} of the plastics material of the plastics film.

Another embodiment of the invention provides the above process, wherein in step C) at least those regions of the plastics moulding obtained in step B) that have not been back-injected are heated to at least a temperature in the range of from 50° C. below the glass transition temperature T_{g} to 50° C. above the glass transition temperature T_{g} of the plastics material of the plastics film.

Another embodiment of the invention provides the above process, wherein in step C) at least those regions of the plastics moulding obtained in step B) that have not been back-injected are heated in the specified temperature region for less than 20 seconds.

Another embodiment of the invention provides the above process, wherein in step C) at least those regions of the plastics moulding obtained in step B) that have not been back-injected are heated in the specified temperature region for less than 15 seconds.

Another embodiment of the invention provides the above process, wherein in step C) at least those regions of the plastics moulding obtained in step B) that have not been back-injected are heated in the specified temperature region for less than 10 seconds.

Another embodiment of the invention provides the above process, wherein the plastic film has a thickness of from 50 μm to 500 μm.

Another embodiment of the invention provides the above process, wherein the plastic film has a thickness of from 75 μm to 400 μm.

Another embodiment of the invention provides the above process, wherein the plastic film has a thickness of from 100 μm to 300 μm.

Another embodiment of the invention provides the above process, wherein the plastic film comprises at least one polycarbonate or copolycarbonate.

Another embodiment of the invention provides the above process, wherein the thermoplastic plastic comprises at least one polycarbonate, copolycarbonate, polyacrylate, copolyacrylate, poly(meth)acrylate, copoly(meth)acrylate, or acrylonitrile-styrene copolymer (ABS).

Another embodiment of the invention provides the above process, wherein the plastic film is transparent or translucent at least in partial areas in the regions that have not been back-injected.

Another embodiment of the invention provides the above process, which further comprises covering the regions of the plastic film that are not to be back-injected with one or more dies or sliders in step A).

Another embodiment of the invention provides the above process, wherein the partial area(s) of the plastics film that have not been back-injected are completely surrounded by back-injected partial areas of the plastics film.

Another embodiment of the invention provides the above process, wherein in step A) a plurality of non-contiguous partial areas of the plastics film are not back-injected, and the partial areas of the plastics film that have not been back-injected are completely surrounded by back-injected partial areas of the plastics film.

Another embodiment of the invention provides the above process, wherein the back-injection in step A) is performed using the window technique.

Yet another embodiment is a plastic moulding obtained by the process according to claim 1.

### BRIEF DESCRIPTION OF THE DRAWINGS

The foregoing summary, as well as the following detailed description of the invention, may be better understood when read in conjunction with the appended drawings. For the purpose of assisting in the explanation of the invention, there are shown in the drawings representative embodiments which are considered illustrative. It should be understood, however, that the invention is not limited in any manner to the precise arrangements and instrumentalities shown.

In the drawings:

FIG. 1 illustrates a plastics film placed into a tool half of an open injection-moulding tool. Dies for covering the regions that are not to be back-injected are fixed to the second tool half.

FIG. 2 illustrates a closed injection-moulding tool containing the plastics film, wherein the dies fixed to the second tool half cover the regions of the plastics film that are not to be back-injected towards the inside of the tool.

FIG. 3 illustrates a closed injection-moulding tool, wherein the plastics film has been back-injected with thermoplastic plastic in the regions not covered with the dies.

FIG. 4 illustrates an open injection-moulding tool, from which the plastics moulding is removed after cooling.

FIG. 5 illustrates a cut-out of the plastics moulding which was removed from the injection-moulding tool after cooling, wherein the bulge in the region that has not been back-injected is visible.

### DETAILED DESCRIPTION

Embodiments of the present invention therefore provides a process for the production of a plastics moulding, wherein
A) a plastics film is back-injected on one side with at least one thermoplastic plastic, one or more partial areas of the plastics film not being back-injected, and
B) the plastics moulding obtained in step A) is cooled,
characterised in that
C) at least those regions of the plastics moulding obtained in step B) that have not been back-injected are then heated again.

Bulges or dents in the regions that have not been back-injected can be removed completely by the process according to the invention. The process according to the invention does not require additional fillers for reducing the shrinkage of the thermoplastic plastic and offers the possibility of using thin plastics films with good light transmission, which can be back-lit even with weak light sources. A further advantage of the process according to the invention is additionally that the component is not under stress in the regions that have not been back-injected, so that there is no associated risk of cracking or fracture in those regions.

The plastics film used in step A) can be printed or coloured with colourings or pigments on one or both sides. Preferably, the plastics film used in step A) is printed on one side. Where a plastics film printed on one side is used in step A), it can be back-injected with the thermoplastic plastic either on the printed side or on the non-printed side. Where back-injection is carried out on the printed side, thermally stable printing inks, as are described, for example, in WO-A 2009/138217, are particularly suitable for the printing.

In preferred embodiments of the process according to the invention, the plastics film used in step A) is formed. Such forming can be carried out by processes known to the person skilled in the art before or after possible printing, but preferably after possible printing. Examples of possible forming processes which may be mentioned are mechanical forming, hydroforming and the high-pressure forming (HPF) process. The high-pressure forming process, which is described, for example, in WO-A 2009/043539 or EP-A 371 425, is preferred.

In step C), at least those regions of the plastics moulding obtained in step B) that have not been back-injected are heated to at least a temperature at which, upon cooling, shrinkage and/or contraction of the plastics film in the regions that have not been back-injected can be achieved. Preferably, in step C) at least those regions of the plastics moulding obtained in step B) that have not been back-injected are heated to at least a temperature in the region above the temperature of 70° C. below the glass transition temperature T_{g}, preferably to at least a temperature in the region above the temperature of 50° C. below the glass transition temperature T_{g} of the plastics material of the plastics film, that is to say to at least a temperature of more than T_{g} minus 70° C. (at least a temperature in the region of >T_{g}-70° C.), preferably to at least a temperature of more than T_{g} minus 50° C. (at least a temperature in the region of >T_{g}-50° C.) of the plastics material of the plastics film. In preferred embodiments, in step C) at least those regions of the plastics moulding obtained in step B) that have not been back-injected are heated to at least a temperature in the range from 50° C. below the glass transition temperature T_{g} to 50° C. above the glass transition temperature T_{g} of the plastics material of the plastics film. Preferably, heating in step C) is effected to at least a temperature in the range from 40° C. below the glass transition temperature T_{g} to 40° C. above the glass transition temperature T_{g} of the plastics material of the plastics film. In preferred embodiments of the present invention, heating in step C) is effected to at least a temperature in the range from 10° C. below the glass transition temperature T_{g} to 40° C. above the glass transition temperature T_{g} of the plastics material of the plastics film. Most particularly preferably, heating is effected to at least a temperature above the glass transition temperature T_{g} in the above-specified ranges above the glass transition temperature T_{g} of the plastics material of the plastics film. Most particular preference is given to temperatures up to 50° C. above, preferably up to 40° C. above the glass transition temperature T_{g} of the plastics material of the plastics film. Where the plastics film contains at least one polycarbonate or copolycarbonate, the regions that have not been back-injected are heated in step C) preferably to at least a temperature above 60° C., particularly preferably above 70° C., most particularly preferably above 100° C.

The glass transition temperatures T_{g} are determined by means of differential scanning calorimetry (DSC) according to standard ISO 113557-2 at a heating rate of 10 K/min with definition of the T_{g} as the mid-point temperature (tangent method).

The temperatures to which at least those regions of the plastics moulding obtained in step B) that have not been back-injected are heated in step C) can be determined, for example, by means of a commercial infrared camera, preferably commercial infrared line cameras for contactless temperature measurement. There are suitable for that purpose, for example, corresponding infrared cameras from Bartec Messtechnik und Sensorik, such as, for example, line pyrometers from Bartec Messtechnik und Sensorik or infrared line cameras from Dias Infrared GmbH.

Preferably, at least those regions of the plastics moulding obtained in step B) that have not been back-injected are heated at the mentioned temperature(s) in step C) for less than 60 seconds, preferably for less than 20 seconds, particularly preferably for less than 15 seconds, most particularly preferably for less than 10 seconds. A time period that is as short as possible is desirable and advantageous in particular for reasons of process efficiency and as regards the temperature load of the plastics materials. It is, however, also possible to heat the regions of the plastics moulding obtained in step B) that have not been back-injected at the mentioned temperature(s) for a longer period.

Heating in step C) can be carried out by any suitable form of heat supply. Heating can be carried out partially in the regions that have not been back-injected and the surrounding regions or over the entire surface of the component. Any desired possibilities between the above-mentioned alternatives are also possible. Heating can be carried out both inside the injection-moulding tool and outside the injection-moulding tool. Inside the injection-moulding tool, the supply of heat by means of ceramic heating elements, for example, is possible. Outside the injection-moulding tool, the supply of heat by means of IR radiators or hot air, for example, is possible.

After being heated again in step C), the plastics moulding so obtained is cooled. Cooling is preferably carried out to a temperature of less than 50° C., particularly preferably less than 40° C., most particularly preferably less than 30° C.

The plastics film used in step A) preferably has a thickness of from 50 μm to 500 μm, particularly preferably from 75 μm to 400 μm, most particularly preferably from 100 μm to 300 μm.

The plastics film used in step A) is preferably a plastics film containing one or more thermoplastic plastics, particularly preferably a plastics film which consists substantially of one or more thermoplastic plastics and conventional plastics additives.

Suitable thermoplastic plastics for the plastics film and the thermoplastic plastic(s) for back-injection are, independently of one another, thermoplastic plastics selected from polymers of ethylenically unsaturated monomers and/or polycondensation products of bifunctional reactive compounds.

Particularly suitable thermoplastic plastics are polycarbonates or copolycarbonates based on diphenols, poly- or copoly-acrylates and poly- or copoly-methacrylates, such as, for example and preferably, polymethyl methacrylate, polymers or copolymers with styrene, such as, for example and preferably, transparent polystyrene, polystyrene acrylonitrile (SAN) or acrylonitrile-butadiene-styrene copolymers (ABS), transparent thermoplastic polyurethanes, as well as polyolefins, such as, for example and preferably, transparent polypropylene types or polyolefins based on cyclic olefins (e.g. TOPAS®, Hoechst), poly- or copoly-condensation products of terephthalic acid, such as, for example and preferably, poly- or copoly-ethylene terephthalate (PET or CoPET), glycol-modified PET (PETG) or poly- or copoly-butylene terephthalate (PBT or CoPBT) or mixtures of those mentioned above.

Most particular preference is given to polycarbonates or copolycarbonates, in particular having mean molecular weights M_{w} of from 500 to 100,000, preferably from 10,000 to 80,000, particularly preferably from 15,000 to 40,000, or blends containing at least one such polycarbonate or copolycarbonate. Preference is further given also to blends of the above-mentioned polycarbonates or copolycarbonates with at least one poly- or copoly-condensation product of terephthalic acid, in particular at least one such poly- or copoly-condensation product of terephthalic acid having a mean molecular weight M_{w} of from 10,000 to 200,000, preferably from 26,000 to 120,000. In particularly preferred embodiments of the invention, the blend is a blend of polycarbonate or copolycarbonate with poly- or copoly-butylene terephthalate. Such a blend of polycarbonate or copolycarbonate with poly- or copoly-butylene terephthalate can preferably be a blend containing from 1 to 90 wt. % polycarbonate or copolycarbonate and from 99 to 10 wt. % poly- or copoly-butylene terephthalate, preferably containing from 1 to 90 wt. % polycarbonate and from 99 to 10 wt. % polybutylene terephthalate, the sum of the amounts being 100 wt. %. Particularly preferably, such a blend of polycarbonate or copolycarbonate with poly- or copoly-butylene terephthalate can be a blend containing from 20 to 85 wt. % polycarbonate or copolycarbonate and from 80 to 15 wt. % poly- or copoly-butylene terephthalate, preferably containing from 20 to 85 wt. % polycarbonate and from 80 to 15 wt. % polybutylene terephthalate, the sum of the amounts being 100 wt. %. Most particularly preferably, such a blend of polycarbonate or copolycarbonate with poly- or copoly-butylene terephthalate can be a blend containing from 35 to 80 wt. % polycarbonate or copolycarbonate and from 65 to 20 wt. % poly- or copoly-butylene terephthalate, preferably containing from 35 to 80 wt. % polycarbonate and from 65 to 20 wt. % polybutylene terephthalate, the sum of the amounts being 100 wt. %.

In preferred embodiments, aromatic polycarbonates or copolycarbonates are particularly suitable as polycarbonates or copolycarbonates.

The polycarbonates or copolycarbonates can, in known manner, be linear or branched.

The preparation of these polycarbonates can be carried out in known manner from diphenols, carbonic acid derivatives, optionally chain terminators and optionally branching agents. Details of the preparation of polycarbonates have been laid down in many patent specifications for about 40 years. By way of example, reference is made here only to Schnell, “Chemistry and Physics of Polycarbonates”, Polymer Reviews, Volume 9, Interscience Publishers, New York, London, Sydney 1964, to D. Freitag U. Grigo, P. R. Müller, H. Nouvertne', BAYER AG, “Polycarbonates” in Encyclopedia of Polymer Science and Engineering, Volume 11, Second Edition, 1988, pages 648-718 and finally to Dres. U. Grigo, K. Kirchner and P. R. Müller “Polycarbonate” in Becker/Braun, Kunststoff-Handbuch, Volume 3/1, Polycarbonate, Polyacetale, Polyester, Celluloseester, Carl Hanser Verlag, Munich, Vienna 1992, pages 117-299.

Suitable diphenols can be, for example, dihydroxyaryl compounds of the general formula (I)

HO—Z—OH (I)

wherein Z is an aromatic radical having from 6 to 34 carbon atoms which can contain one or more optionally substituted aromatic nuclei and aliphatic or cycloaliphatic radicals or alkylaryls or heteroatoms as bridge members.

Particularly preferred dihydroxyaryl compounds are resorcinol, 4,4′-dihydroxydiphenyl, bis-(4-hydroxyphenyl)-diphenyl-methane, 1,1-bis-(4-hydroxyphenyl)-1-phenyl-ethane, bis-(4-hydroxyphenyl)-1-(1-naphthyl)-ethane, bis-(4-hydroxyphenyl)-1-(2-naphthyl)-ethane, 2,2-bis-(4-hydroxyphenyl)-propane, 2,2-bis(3,5-dimethyl-4-hydroxyphenyl)-propane, 1,1-bis-(4-hydroxyphenyl)-cyclohexane, 1,1-bis-(3,5-dimethyl-4-hydroxyphenyl)-cyclohexane, 1,1-bis-(4-hydroxyphenyl)-3,3,5-trimethyl-cyclohexane, 1,1′-bis-(4-hydroxyphenyl)-3-diisopropyl-benzene and 1,1′-bis-(4-hydroxyphenyl)-4-diisopropyl-benzene.

Most particularly preferred dihydroxyaryl compounds are 4,4′-dihydroxydiphenyl, 2,2-bis-(4-hydroxyphenyl)-propane and 1,1-bis-(4-hydroxyphenyl)-3,3,5-trimethyl-cyclohexane.

A most particularly preferred copolycarbonate can be prepared using 1,1-bis-(4-hydroxyphenyl)-3,3,5-trimethyl-cyclohexane and 2,2-bis-(4-hydroxyphenyl)-propane.

Suitable carbonic acid derivatives can be, for example, diaryl carbonates of the general formula (II)

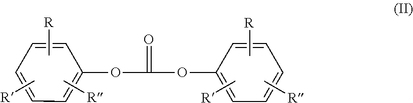

wherein
R¹, R′ and R″, which may be the same or different, independently of one another represent hydrogen, linear or branched C₁-C₃₄-alkyl, C₇-C₃₄-alkylaryl or C₆-C₃₄-aryl, R can further also denote —COO—R′″, wherein R′″ represents hydrogen, linear or branched C₁-C₃₄-alkyl, C₇-C₃₄-alkylaryl or C₆-C₃₄-aryl.

Particularly preferred diaryl compounds are diphenyl carbonate, 4-tert-butylphenyl-phenyl carbonate, di-(4-tert-butylphenyl) carbonate, biphenyl-4-yl-phenyl carbonate, di-(biphenyl-4-yl) carbonate, 4-(1-methyl-1-phenylethyl)-phenyl-phenyl carbonate, di-[4-(1-methyl-1-phenylethyl)-phenyl]carbonate and di-(methylsalicylate) carbonate.

Diphenyl carbonate is most particularly preferred.

It is possible to use both one diaryl carbonate and different diaryl carbonates.

In order to control or change the end groups it is additionally possible, for example, to use as chain terminators one or more monohydroxyaryl compound(s) which has/have not been used for the preparation of the diaryl carbonate(s) used. Such compounds can be those of the general formula (III)

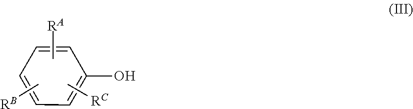

wherein
R^{A} represents linear or branched C₁-C₃₄-alkyl, C₇-C₃₄-alkylaryl, C₆-C₃₄-aryl or —COO—R^{D}, wherein R^{D} represents hydrogen, linear or branched C₁-C₃₄-alkyl, C₇-C₃₄-alkylaryl or C₆-C₃₄-aryl, and
R^{B}, R^{C}, which may be the same or different, independently of one another represent hydrogen, linear or branched C₁-C₃₄-alkyl, C₇-C₃₄-alkylaryl or C₆-C₃₄-aryl.

Preference is given to 4-tert-butylphenol, 4-isooctylphenol and 3-pentadecylphenol.

Suitable branching agents can be compounds having three or more functional groups, preferably those having three or more hydroxyl groups.

Preferred branching agents are 3,3-bis-(3-methyl-4-hydroxyphenyl)-2-oxo-2,3-dihydroindole and 1,1,1-tri-(4-hydroxyphenyl)-ethane.

In preferred embodiments of the invention, suitable poly- or copoly-condensation products of terephthalic acid are polyalkylene terephthalates. Suitable polyalkylene terephthalates are, for example, reaction products of aromatic dicarboxylic acids or reactive derivatives thereof (e.g. dimethyl esters or anhydrides) and aliphatic, cycloaliphatic or araliphatic diols and mixtures of these reaction products.

Preferred polyalkylene terephthalates can be prepared by known methods from terephthalic acid (or reactive derivatives thereof) and aliphatic or cycloaliphatic diols having from 2 to 10 carbon atoms (Kunststoff-Handbuch, Vol. VIII, p. 695 ff, Karl-Hanser-Verlag, Munich 1973).

Preferred polyalkylene terephthalates contain at least 80 mol %, preferably 90 mol %, terephthalic acid radicals, based on the dicarboxylic acid component, and at least 80 mol %, preferably at least 90 mol %, ethylene glycol and/or 1,4-butanediol radicals, based on the diol component.

Preferred polyalkylene terephthalates can contain, in addition to terephthalic acid radicals, up to 20 mol % of radicals of other aromatic dicarboxylic acids having from 8 to 14 carbon atoms or of aliphatic dicarboxylic acids having from 4 to 12 carbon atoms, such as, for example, radicals of phthalic acid, isophthalic acid, naphthalene-2,6-dicarboxylic acid, 4,4′-diphenyldicarboxylic acid, succinic, adipic, sebacic acid, azelaic acid, cyclohexanediacetic acid.

Preferred polyalkylene terephthalates can contain, in addition to ethylene glycol and/or 1,4-butanediol radicals, up to 20 mol % of other aliphatic diols having from 3 to 12 carbon atoms or of cycloaliphatic diols having from 6 to 21 carbon atoms, for example radicals of 1,3-propanediol, 2-ethyl-1,3-propanediol, neopentyl glycol, 1,5-pentanediol, 1,6-hexanediol, cyclohexane-1,4-dimethanol, 3-methyl-2,4-pentanediol, 2-methyl-2,4-pentanediol, 2,2,4-trimethyl-1,3-pentanediol and 2-ethyl-1,6-hexanediol, 2,2-diethyl-1,3-propanediol, 2,5-hexanediol, 1,4-di-([beta]-hydroxyethoxy)-benzene, 2,2-bis-(4-hydroxycyclohexyl)-propane, 2,4-dihydroxy-1,1,3,3-tetramethyl-cyclobutane, 2,2-bis-(3-[beta]-hydroxyethoxyphenyl)-propane and 2,2-bis-(4-hydroxypropoxyphenyl)-propane (see DE-OS 24 07 674, 24 07 776, 27 15 932).

The polyalkylene terephthalates can be branched by the incorporation of relatively small amounts of tri- or tetra-hydric alcohols or tri- or tetra-basic carboxylic acids, as are described, for example, in DE-OS 19 00 270 and U.S. Pat. No. 3,692,744. Examples of preferred branching agents are trimesic acid, trimellitic acid, trimethylol-ethane and -propane and pentaerythritol.

Preferably, not more than 1 mol % of the branching agent, based on the acid component, is used.

Particular preference is given to polyalkylene terephthalates which have been prepared solely from terephthalic acid and reactive derivatives thereof (e.g. dialkyl esters thereof) and ethylene glycol and/or 1,4-butanediol, and mixtures of such polyalkylene terephthalates.

Preferred polyalkylene terephthalates are also copolyesters prepared from at least two of the above-mentioned acid components and/or from at least two of the above-mentioned alcohol components; particularly preferred copolyesters are polyethylene glycol/1,4-butanediol)terephthalates.

The polyalkylene terephthalates that are preferably used as a component preferably have an intrinsic viscosity of approximately from 0.4 to 1.5 dl/g, preferably from 0.5 to 1.3 dl/g, in each case measured in phenol/o-dichlorobenzene (1:1 parts by weight) at 25° C.

In preferred embodiments of the process according to the invention, the plastics film contains at least one polycarbonate or copolycarbonate.

In preferred embodiments of the process according to the invention, the thermoplastic plastic contains at least one polycarbonate or copolycarbonate, a polyacrylate or copolyacrylate, a poly(meth)acrylate or copoly(meth)acrylate or an acrylonitrile-butadiene-styrene copolymer (ABS).

The regions of the plastics film that are not to be back-injected are preferably covered with one or more dies or sliders in step A) so that one or more partial areas of the plastics film are not back-injected.

In preferred embodiments of the process according to the invention, the partial area(s) of the plastics film that has(have) not been back-injected are completely surrounded by back-injected partial areas of the plastics film after the back-injection. In particularly preferred embodiments of the process according to the invention, a plurality of non-contiguous partial areas of the plastics film are not back-injected in step A) and the partial areas of the plastics film that have not been back-injected are completely surrounded by back-injected partial areas of the plastics film after the back-injection.

The back-injection in step A) is preferably carried out by means of the window technique. The window technique, in which the regions of the plastics film that are not to be back-injected are covered with one or more dies or sliders in step A) so that one or more partial areas of the plastics film are not back-injected, is known to the person skilled in the art.

The back-injection of the plastics film is carried out by processes known to the person skilled in the art. For example, a plastics film can to this end be placed into a first half of an open injection-moulding tool and then the tool can be closed by applying a second half of the tool to the first half so that a cavity (gap, hollow space) forms between the film and the second tool half, and the plastics film in the tool can then be back-injected with thermoplastic plastic by introducing the thermoplastic plastic into the cavity. The dies or sliders used to cover the regions that are not to be back-injected can thereby preferably be fixed to the second half of the tool and cover the regions that are to be kept free when the tool is closed.

Where a plastics film printed on one side is used in step A), it can be placed into the first tool half either with the printed side facing the wall of the tool or with the printed side facing away from the wall of the tool.

After the back-injection, the tool is opened after partial or complete cooling in step B). Step C) can then take place in one of the two tool halves after the tool has been opened. Alternatively, it is also possible to remove the plastics moulding from the tool after the cooling in step B) and carry out step C) outside the tool. The plastics moulding can also be removed from the tool before intended complete cooling is achieved and cooling can be completed outside the tool. This procedure can have the advantage, for example, that, in some embodiments of the present invention, sufficient shrinkage of the moulding obtained in step A) cannot be achieved or cannot be achieved quickly enough in step B) with the remaining tool temperature.

Cooling in step B) of the plastics moulding obtained in step A) prior to heating again in step C) is preferably carried out to a temperature at which complete shrinkage and/or contraction of the plastics moulding obtained in step A) can take place. Cooling in step B) of the plastics moulding obtained in step A) prior to heating again in step C) is preferably carried out to a temperature of below 60° C., particularly preferably below 50° C., most particularly preferably below 40° C. It is further preferred for the plastics moulding obtained in step A) not to be overcooled in step B) prior to heating again in step C), that is to say not to be cooled to a temperature below 0° C., preferably not to a temperature below 10° C. In preferred embodiments, cooling in step B) of the plastics moulding obtained in step A) prior to heating again in step C) is carried out to room temperature, room temperature being understood within the context of the invention as being a temperature of from 15 to 25° C., in particular 23° C.

In the regions that have not been back-injected, preferably at least partial areas of the plastics film are transparent or translucent, that is to say light-transmitting, in order to permit back-lighting in those transparent or translucent regions. The plastics film can be 100% light-transmitting for light in the visible wavelength range at least in partial areas of the regions that have not been back-injected; preferably, the plastics film is translucent at least in partial areas in the regions that have not been back-injected. Within the context of the invention, translucency is to be understood as being a transmission of light in the visible wavelength range of more than 20% and less than 100%, preferably more than 50% and less than 100%, particularly preferably more than 70% and less than 100%. The visible wavelength range of light extends over the wavelength range from 380 to 780 nm. The light transmission can be measured using a Hunter UltraScanPRO with diffuse/8° geometry.

It is, however, also possible for the plastics film to be neither transparent nor translucent at least in partial areas in the regions that have not been back-injected, in order to make operating elements, for example capacitive switches or mechanical switches, accessible.

The present invention further provides a plastics moulding which is obtainable by the process according to the invention.

Plastics mouldings produced by the process according to the invention are suitable, for example, for use in electronic devices, domestic devices, mobile telephones, computers, such as, for example, for computer keyboards, in vehicle interiors, such as, for example, in car interiors and in aircraft or railway vehicle interiors, etc. Plastics mouldings produced by the process according to the invention can be used in such applications, for example, as operating elements which are to be accessible to the user even in the dark by back-lighting.

FIGS. 1 to 5 describe, in schematic form, the production of a plastics moulding according to the invention by means of a form of the window technique.

FIG. 1 shows a plastics film (2) placed into a tool half (1) of an open injection-moulding tool. Dies (4) for covering the regions that are not to be back-injected are fixed to the second tool half (3).

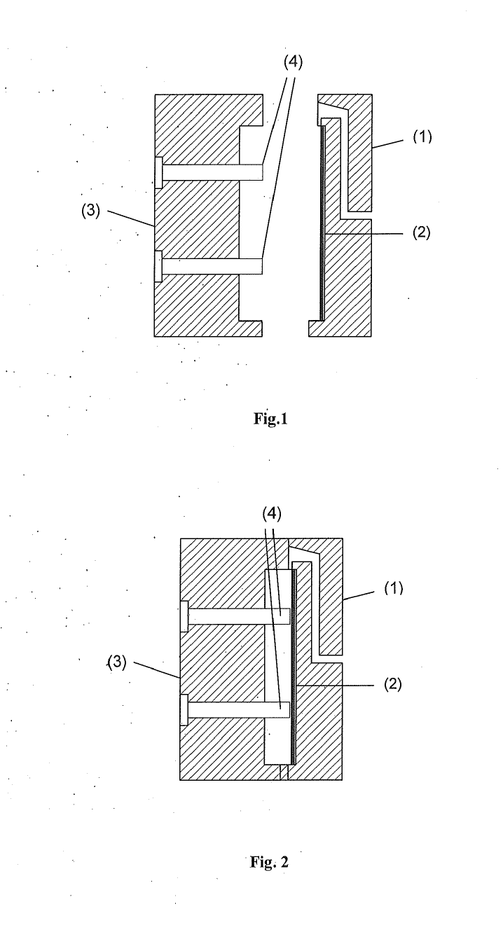

FIG. 2 shows the closed injection-moulding tool containing the plastics film (2), the dies (4) fixed to the second tool half (3) covering the regions of the plastics film (2) that are not to be back-injected towards the inside of the tool.

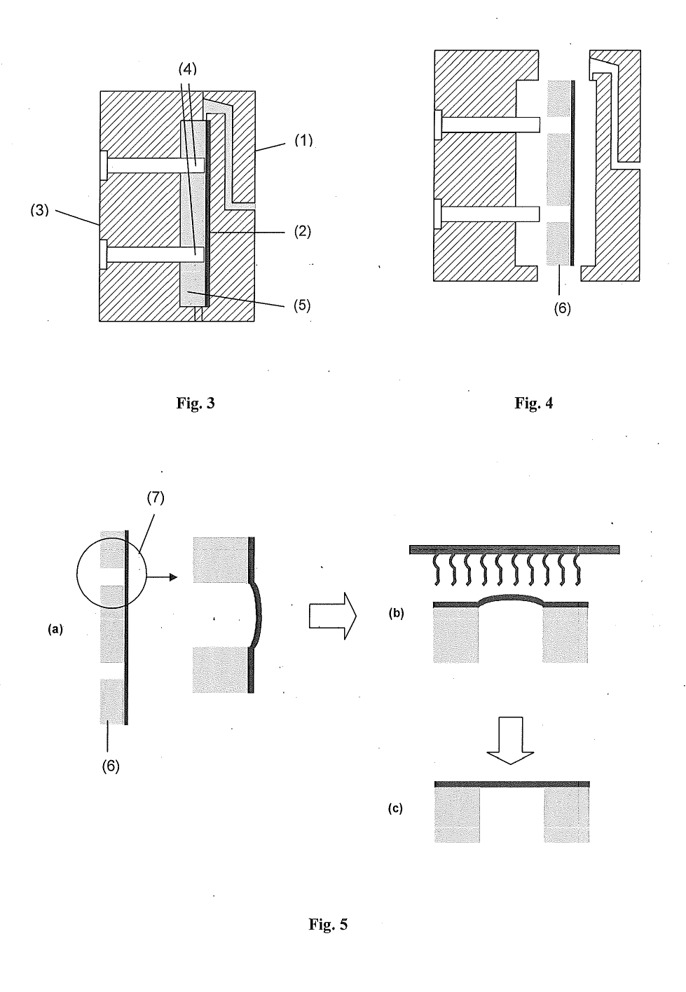

FIG. 3 shows the closed injection-moulding tool, wherein the plastics film (2) has been back-injected with thermoplastic plastic (5) in the regions not covered with the dies (4).

FIG. 4 shows the open injection-moulding tool, from which the plastics moulding (6) is removed after cooling.

FIG. 5 shows a cut-out (7) of the plastics moulding (6) which was removed from the injection-moulding tool after cooling, wherein the bulge in the region that has not been back-injected is visible (see (a)). FIG. 5 additionally shows how this bulge is removed by heating according to the invention (see (b)) and a flat surface is achieved in the region that has not been back-injected (see (c)).

The examples which follow serve to illustrate the invention by way of example and are not to be interpreted as limiting.

### EXAMPLES

Three polycarbonate films (Makrofol® DE) having different thicknesses of 150 μm, 175 μm and 200 μm (glass transition temperature T_{g}: 145° C.) and a film of a polycarbonate/polybutylene terephthalate blend (Bayfol® CR) having a layer thickness of 375 μm (glass transition temperature T_{g}: 125° C.) were printed beforehand with a screen printing ink. Noriphan® HTR was used as the screen printing ink.

The glass transition temperature T_{g} was determined in each case by means of differential scanning calorimetry (DSC) according to standard ISO 113557-2 at a heating rate of 10 K/min, in the second heating operation and with definition of the T_{g} as the mid-point temperature (tangent method).

The polycarbonate films were then back-injected with a thermoplastic polycarbonate (Makrolon® 2405) in an injection-moulding tool. The polycarbonate/polybutylene terephthalate blend film was back-injected with a thermoplastic polycarbonate/ABS blend (Bayblend® T65) in an injection-moulding tool. The tests were carried out on an injection-moulding machine of the Arburg Allrounder 570 C type with a closing force of 200 t. To that end, a sheet die having a wall thickness of 2.5 mm with apertures of different shapes (some round apertures with diameters of from 10 to 30 mm, some rectangular and square apertures with edge lengths of from 10 to 30 mm) was used. The melt temperature was 280° C. and the tool temperature was 60° C. The fill time was measured at about 2.8 seconds for Makrolon® 2405 and Bayblend® T65. In order to keep specific regions of the film free of back-injected plastics material, the window technique process was used. To that end, on closure of the tool, dies covered the film at precisely those areas which were to be kept free. Accordingly, during the back-injection, plastics melt was successfully prevented from reaching those regions. After filling, the back-injected moulding was cooled to room temperature (23° C.). In all four cases (polycarbonate films having a film thickness of 150 μm, 175 μm, 200 μm and polybutylene terephthalate blend film having a film thickness of 375 μm), bulges formed in the regions of the film that had not been back-injected.

In order to eliminate the bulges, the moulding was removed from the tool and the regions of the film that had not been back-injected with plastics material were heated again for a short time using a commercial IR ceramic radiator and alternatively using a hot-air gun. The polycarbonate films were thereby heated again to a temperature of 175° C., and the polybutylene terephthalate film was heated to 155° C. The temperature of the films was measured using a commercial line pyrometer from Bartec Messtechnik and Sensorik, the distance from the camera to the film surface being 56 c

The heating time was varied in the range of from 0.5 to 5 seconds for the tests. It made no difference to the end result whether a long heating time with low radiator power or a short heating time with high power was used. The components no longer exhibited bulges after being heated again and cooled.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A process for the production of a plastics moulding, comprising
A) back-injecting a plastic film on a first side with at least one thermoplastic plastic, wherein one or more partial areas of the plastics film are not back-injected,
B) cooling the plastics moulding obtained in step A), and
C) subsequently heating at least those regions of the plastics moulding obtained in step B) that have not been back-injected again.

2. The process according to claim 1, wherein the plastic film used in step A) is formed.

3. The process according to claim 1, wherein the plastic film used in step A) is printed on one side.

4. The process according to claim 1, wherein in step C) at least those regions of the plastics moulding obtained in step B) that have not been back-injected are heated to at least a temperature in the region above the temperature of 70° C. below the glass transition temperature T_{g} of the plastics material of the plastics film.

5. The process according to claim 1, wherein in step C) at least those regions of the plastics moulding obtained in step B) that have not been back-injected are heated to at least a temperature in the range of from 50° C. below the glass transition temperature T_{g} to 50° C. above the glass transition temperature T_{g} of the plastics material of the plastics film.

6. The process according to claim 1, wherein in step C) at least those regions of the plastics moulding obtained in step B) that have not been back-injected are heated in the specified temperature region for less than 20 seconds.

7. The process according to claim 1, wherein in step C) at least those regions of the plastics moulding obtained in step B) that have not been back-injected are heated in the specified temperature region for less than 15 seconds.

8. The process according to claim 1, wherein in step C) at least those regions of the plastics moulding obtained in step B) that have not been back-injected are heated in the specified temperature region for less than 10 seconds.

9. The process according to claim 1, wherein the plastic film has a thickness of from 50 μm to 500 μm.

10. The process according to claim 1, wherein the plastic film has a thickness of from 75 μm to 400 μm.

11. The process according to claim 1, wherein the plastic film has a thickness of from 100 μm to 300 μm.

12. The process according to claim 1, wherein the plastic film comprises at least one polycarbonate or copolycarbonate.

13. The process according to claim 1, wherein the thermoplastic plastic comprises at least one polycarbonate, copolycarbonate, polyacrylate, copolyacrylate, poly(meth)acrylate, copoly(meth)acrylate, or acrylonitrile-styrene copolymer (ABS).

14. The process according to claim 1, wherein the plastic film is transparent or translucent at least in partial areas in the regions that have not been back-injected.

15. The process according to claim 1, further comprising covering the regions of the plastic film that are not to be back-injected with one or more dies or sliders in step A).

16. The process according to claim 1, wherein the partial area(s) of the plastics film that have not been back-injected are completely surrounded by back-injected partial areas of the plastics film.

17. The process according to claim 1, wherein in step A) a plurality of non-contiguous partial areas of the plastics film are not back-injected, and the partial areas of the plastics film that have not been back-injected are completely surrounded by back-injected partial areas of the plastics film.

18. The process according to claim 1, wherein the back-injection in step A) is performed using the window technique.

19. A plastic moulding obtained by the process according to claim 1.
